(19) United States
(12) Patent Application Publication
(10) Pub. No.: US 2009/0165568 A1
(43) Pub. Date: Jul. 2, 2009

(54) ELECTRONIC TORQUE TOOL WITH MULTIPLE COLOR DISPLAY ASSEMBLY

(76) Inventor: Chih-Ching HSIEH, Taichung City (TW)

Correspondence Address: Chien-Hui Su, P. O. Box 70-121 Taichung, Taichung City, 40899, TW

(21) Appl. No.: 11/964,692

(22) Filed: Dec. 26, 2007

(51) Int. Cl. G01L 3/00

(52) U.S. Cl. 73/862.08

(57) ABSTRACT

An electronic torque tool with multiple color display assembly comprises a driving portion formed at one end of the spanner body for driving an object; a handle formed at another end of the spanner body for being held by users; and a display portion installed between the driving portion and the handle; the display portion having a display screen for displaying related data; and a color display control module being built in the display screen for emitting lights of different colors so as to display the variation of data and change the background of the screen so that the user can identify the data and variation f the data easily and clearly.

### FIELD OF THE INVENTION

The present invention relates to torque tools, and particularly to an electronic torque tool with a display of multiple colors, which present data and the variation of the data by different colors.

### BACKGROUND OF THE INVENTION

Driving tools are widely used in various fields for driving screws to assembly objects, such as airplanes, boats, cars, etc. However currently to have precise operation, electronic driving tools are developed for controlling the operation well. The main object of the electronic driving tools is to show the values of torques.

However for more precise structures, the requirement in torque applied is strictly limited, but in the assembly or detached works, there are different kinds of screws to be operated, the screws have different working requirements, for example they are driven by different torques. Thus, in operation, the worker must change the setting repeatedly for suiting different kinds of screws. However the process is tedious and time consume. In U.S. Pat. No. 7,107,884, electronic torque wrench is disclosed, which comprises: a housing assembly including an inner generally tubular core having first and second elongated apertures formed therein, a grip sleeve telescopically received over the core and having first and second openings therein respectively communicating with the first and second apertures, a user interface assembly coupled to the core and also coupled to a torque measuring apparatus, said user interface assembly disposed in the first aperture and the first opening, and a power assembly coupled to the core and disposed in the second aperture and the second opening and electrically connected to the user interface assembly; a workpiece-engaging head carried by the core; and sensing apparatus carried by the housing assembly and connected to the torque measuring apparatus.

Moreover, the display screen of the driving tool is single color display, or displays objects with only one color. The screen is dull in a dark environment or is not clear due to dirt, oil or dregs are adhered thereon on the operation and thus cannot capture the attention of users. It is often that the user does not take attention to the value displayed in the display screen especially in a dark environment. As a result, it is often that some faults occur in operation due to the errors in the torques applied. Thus, in the prior art wrench, sounds are emitted to alert the people to take attention to the torque applied.

However the prior art design by using sounds for alert can not suitable for various environment, such as in noisy car maintenance plant full of metal cutting noises, collision noises of steel sheets, etc. which will make the sounds from the wrench transferring to the worker, even the most of the workers wear with ear masks so that they can not hear the sound from the wrenches. Furthermore, the prior art emits sound when the torque is over a preset value, while the worker drives an object repeatedly. When he (or she) hears the sound and then to slow or stop the driving operation, it is often that the object is rotated through one more half circle so that the screw must be loosed, even the screw will be destroyed. Thus, the prior art has the defects of not being used in noise environment and the torque not be to be provided gradually. Thus there is an eager demand for a novel design which can improve the defect in the prior art.

### SUMMARY OF THE INVENTION

The present invention relates to an electronic torque tool with multiple color display assembly so that the electronic torque tool can suit the operation environment and the present invention can present operation data gradually.

To achieve above object, the present invention provides an electronic torque tool with multiple color display assembly, comprising: a driving portion formed at one end of the spanner body for driving an object; a handle formed at another end of the spanner body for being held by users; and a display portion installed between the driving portion and the handle; the display portion having a display screen for displaying related data; and a color display control module being built in the display screen for emitting lights of different colors so as to display the variation of data and change the background of the screen so that the user can identify the data and variation f the data easily and clearly.

When an operation data do not achieve a preset range, the color display control module presents a first color; when the operation data approaches to the preset range, the color display control module presents a second color; and when the operation data is over the preset range, the color display control module presents a third color so as to alert the operator. Besides, the color display control module presents the state of the display screen by colors different from the colors showing the data or variation of data.

From above discussion, it is known that the color display control module of the display screen will emit light of different color so as to display the operation data clearly. Thus, if the light source is insufficient, or in noisy environment, it will not confine by the working environment. The different color will catch the attention of the operator so as to alter the variation of data and thus to have correct operation.

Therefore, there is an eager demand for a novel driving tool which can be set easily and conveniently and the specification can be displayed apparently so that the setting time is saved, while the user can identify the setting quickly and correctly.

### SUMMARY OF THE INVENTION

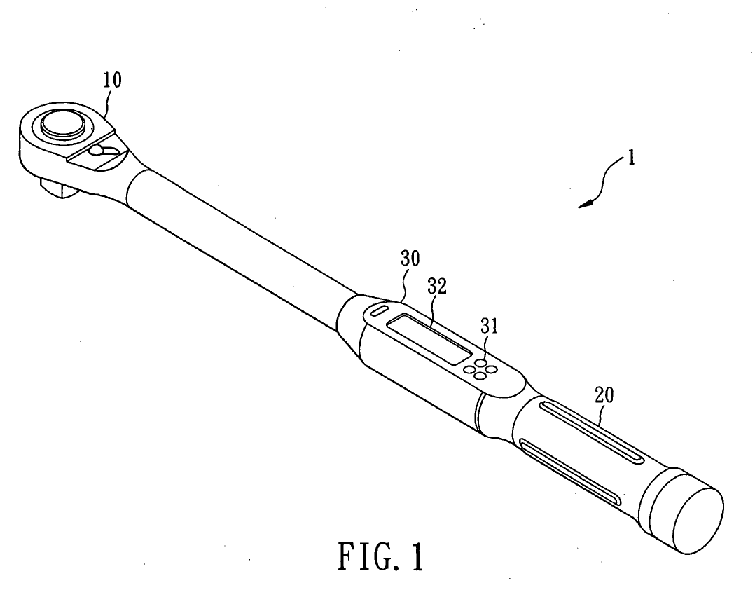

FIG. 1 is a perspective view of the electronic torque tool with multiple color display assembly of the present invention.

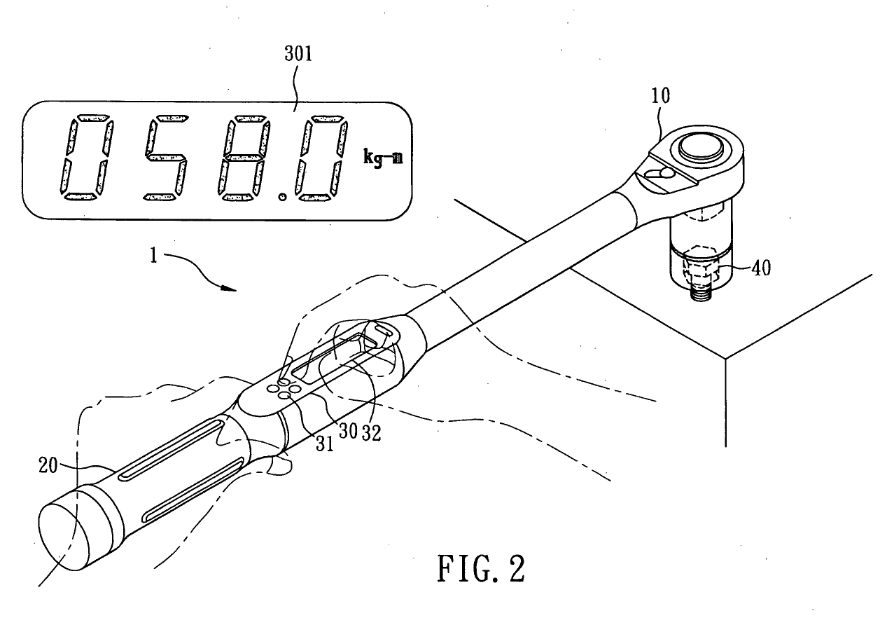

FIG. 2 is a schematic view showing the element of the driving portion of the present invention.

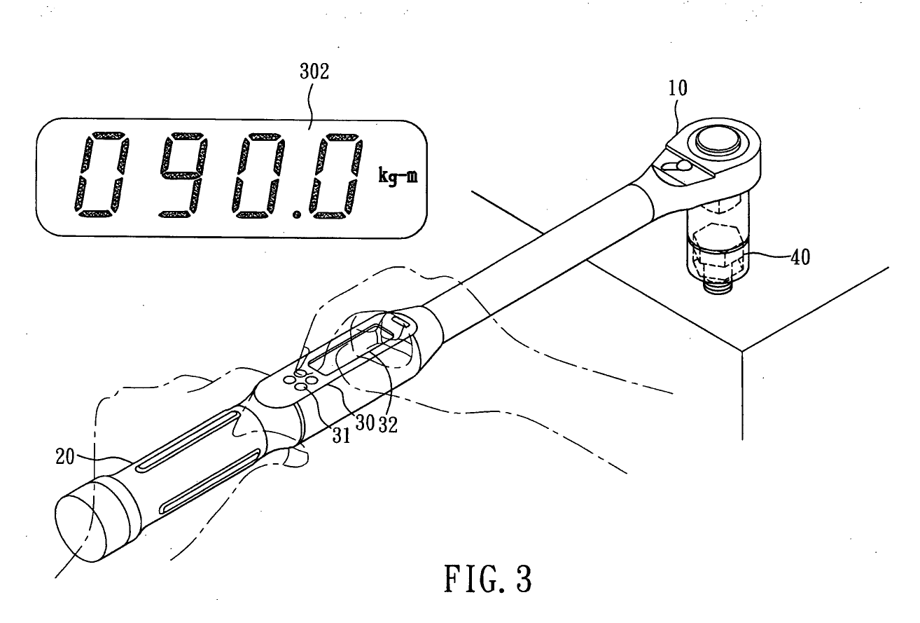

FIG. 3 is a schematic view showing the use of the present invention.

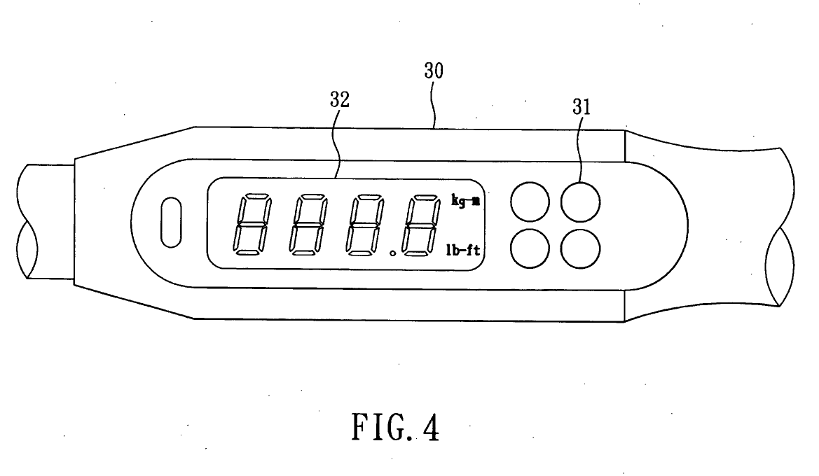

FIG. 4 is a schematic view showing that the display screen of the present invention is at a normal state or a set state.

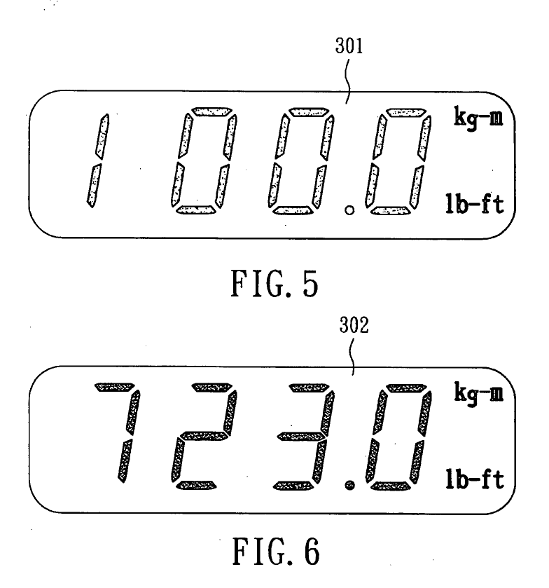

FIG. 5 is a schematic view showing that the operation data do not achieve to a preset range in the color display control module of the present invention.

FIG. 6 is a schematic view showing that the operation data approach to a preset range in the color display control module of the present invention.

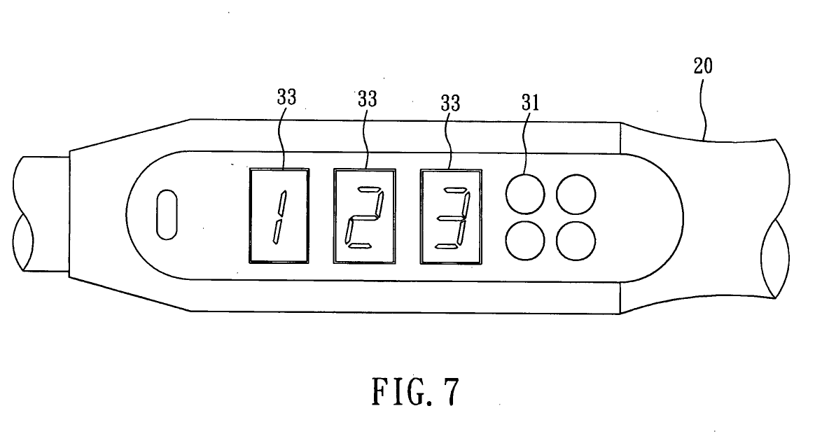

FIG. 7 is a schematic view showing that the operation data is over to a preset range in the color display control module of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to FIG. 1, the structure of the present invention is illustrated. The spanner body 1 of present invention has the following elements.

A driving portion 10 is formed at one end of the spanner body 1 for driving an object. In this embodiment, the driving portion 10 is a D type driving head.

A handle 20 is at another end of the spanner body 1 for being held by users.

A display portion 30 is installed between the driving portion 10 and the handle 20. The display portion 30 has four buttons 31 and a display screen 32. The display screen 32 serves for displaying related data. A color display control module 321 is built in the display screen 32 for emitting lights of different colors so as to display data and the variation of data and change the background of the screen so that the user can identify the data and variation f the data easily and clearly.

Referring to FIGS. 3 to 7, the embodiment of the present invention is illustrated, in that the value of torque is used as an example for showing the effect of the present invention.

Referring to FIG. 3, the user pushes the button 31 for inputting the operation specification and instructions into the spanner body 1. Then, the spanner body 1 is used to drive the screw unit 40. Referring to FIGS. 4 and 5, when the value of the torque increases gradually, but not achieves to a predetermined range, the color display control module 321 will display a first color 3211 which represents that the value of the torque increase gradually. At this stage, the background of the display screen 32 emits the first color 3211. Thus the operator can drive the spanner body 1 easily and comfortable. With referring to FIG. 6, when the value of the torque approaches to the preset range, the display color display control module 321 will emit a second color 3212 for displaying the value of the torque. At this stage, the background of the display screen 32 will display the second color 3212. Thus the operator will be attracted by the variation of the color so as to alert the operation is coming to an end and thus the force applied to the spanner is reduced to achieve the preset range steadily. Referring to FIG. 7, if the value of the torque is over the preset range due to the carelessness of the operator, the color display control module 321 will preset a third color 3213 to present the value of the torque. At this moment, the background of the display screen 32 will present the third color 3213 to alert the operator strongly about that the torque applied is wrong.

From above discussion, it is known that the advantage of the present invention is that the color display control module 321 of the display screen 32 will emit light of different color so as to display the operation data clearly. Thus, if the light source is insufficient, or in noisy environment, it will not be confined by the working environment. The different color will catch the attention of the operator so as to alter the variation of data and thus to have correct operation.

Moreover, in the present invention, the color emitted from the color display control module 321 can be varied from shallow color to deep color, for example, the first color 3211 is yellow color, the second color 3212 is green color and the third color 3213 is red color. Or the colors are changed from light color to deep color. The color display control module 321 can present different colors for presenting different data and the variation of the data.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electronic torque tool with multiple color display assembly, comprising:
a driving portion formed at one end of the spanner body for driving an object;
a handle formed at another end of the spanner body for being held by users; and
a display portion installed between the driving portion and the handle;
the display portion having a display screen for displaying related data; and a color display control module being built in the display screen for emitting lights of different colors so as to display the variation of data and change the background of the screen so that the user can identify the data and variation f the data easily and clearly.

2. The electronic torque tool with multiple color display assembly as claimed in claim 1, wherein when an operation data do not achieve a preset range, the color display control module presents a first color; when the operation data approaches to the preset range, the color display control module present a second color; and when the operation data is over the preset range, the color display control module present a third color so as to alert the operator.

3. The electronic torque tool with multiple color display assembly as claimed in claim 2, wherein the first color is yellow color, the second color is green color and the third color is red color.

4. The electronic torque tool with multiple color display assembly as claimed in claim 1, wherein the color display control module presents colors from shallow color to deep color.

5. The electronic torque tool with multiple color display assembly as claimed in claim 1, wherein the color display control module presents colors from dark color to bright color.

6. The electronic torque tool with multiple color display assembly as claimed in claim 1, wherein the color display control module presents the states of the display screen by colors different from those present the data and variation of data.

7. The electronic torque tool with multiple color display assembly as claimed in claim 1, wherein the driving portion has a plurality of buttons.
